(19) United States
(12) Patent Application Publication
(10) Pub. No.: US 2015/0013262 A1
(43) Pub. Date: Jan. 15, 2015

(54) Securing Dowel Baskets over Vapor Retarders/Barriers

(71) Applicant: Stego Industries, LLC, San Clemente, CA (US)

(72) Inventors: John Wilkes, Dawsonville, GA (US); Bret N. Houck, Mission Viejo, CA (US); Peter Craig, Spokane, WA (US)

(21) Appl. No.: 14/328,667

(22) Filed: Jul. 10, 2014

Related U.S. Application Data
(60) Provisional application No. 61/844,577, filed on Jul. 10, 2013.

(51) Int. Cl. E01C 11/14; B29C 65/56; E04C 5/16; B29C 65/48

(52) U.S. Cl. CPC E01C 11/14; B29C 65/48; B29C 65/565; E04C 5/16
USPC 52/677; 156/66

(57) ABSTRACT

This disclosure describes an attachment apparatus for securing position and elevation of dowels above a vapor barrier without compromising the ability of the vapor barrier to impede vapor seepage. Various embodiments of the attachment apparatus include, but are not limited to, a ring-shaped force-fit attachment apparatus, magnetically coupled plates, a saddle attachment apparatus, a stake with a flange, a self-sealing stake, and a retainer clip attachment apparatus.

This application claims priority to U.S. Provisional Patent Application Ser. No. 61/844,577, which was filed Jul. 10, 2013, the entire contents of which is incorporated herein by reference.

### BACKGROUND

Before pouring concrete, workers typically lay down a vapor retarder/barrier (hereinafter collectively referred to as “vapor barrier”) to prevent seepage of water and/or water vapor from the ground into the concrete, which would endanger the integrity of the concrete and/or flooring system. Workers then place dowel baskets holding dowels onto the vapor barrier, the dowels designed to increase structural integrity of the concrete formation and/or to stabilize joints in the concrete over the vapor barrier. The exact placement and elevation of dowels held by the dowel baskets is important to maintain this structural integrity. However, during the concrete pouring process, oftentimes the pressure caused by pouring the concrete causes the dowel baskets to shift, causing non-optimal placement and/or elevation of the dowels. In order to prevent this, dowel baskets are sometimes staked down into the vapor barrier. However, piercing the barrier in this manner compromises the integrity of the vapor barrier, possibly allowing water vapor from the ground below to reach the concrete. As such, there exists a need to secure dowel baskets in place, thus ensuring the proper positioning of the dowels, without perforating the underlying vapor barrier.

### SUMMARY

This summary is provided to introduce simplified concepts of apparatuses and methods for securing the position and elevation of dowels above a vapor barrier without compromising the integrity and function of the vapor barrier, which is further described below in the Detailed Description. This summary is not intended to identify essential features of the claims subject matter, nor is it intended for use in determining the scope of the claims subject matter.

This disclosure describes an attachment apparatus for securing the position and elevation of dowels above a vapor barrier without puncturing the vapor barrier. Various embodiments of the attachment apparatus include, but are not limited to, a ring-shaped force-fit attachment apparatus, magnetically coupled plates and saddle attachment apparatus, a stake with a flange, and a self-sealing stake.

### BRIEF DESCRIPTION OF THE DRAWINGS

The figures are described in more detail below in the Detailed Description section of this application. In the figures, the left-most digit of a reference number identifies the figure in which the reference number first appears. The use of the same reference numbers in different figures indicates similar or identical items. In the figures:

FIG. 1 depicts an exemplary dowel basket that supports isometric plate dowels, one of the many kinds of dowels that may be used.

FIG. 2 depicts various exemplary dowels.

FIG. 3 depicts an exemplary configuration that includes a dowel basket configured to attach to a ring-shaped, force-fit attachment mechanism, which in turn is adhered to a vapor barrier, which covers a ground surface.

FIGS. 4A and 4B depict an exemplary ring-shaped, force-fit attachment apparatus and an alternative attachment mechanism, each for attaching a dowel basket to a vapor barrier without piercing the vapor barrier.

FIG. 5A depicts a side view of an exemplary retainer clip attachment apparatus.

FIG. 5B depicts a top view of an exemplary retainer clip attachment apparatus.

FIG. 5C depicts an alternative exemplary retainer clip attachment apparatus.

### DETAILED DESCRIPTION

The techniques discussed herein facilitate securing the position and elevation of dowels above a vapor barrier without compromising the integrity and function of the vapor barrier. In one embodiment, an attachment apparatus may comprise a flat base portion that may adhere to a vapor barrier without piercing the barrier. In addition, the apparatus may comprise a ring-shaped retention member, into which a portion of a dowel basket may snap into place via a force fit. Therefore, the apparatus secures a dowel basket in place without piercing the vapor barrier and without compromising the integrity of the concrete poured thereon. The term “techniques,” for instance, may refer to system(s), method(s), apparatus(es), or module(s).

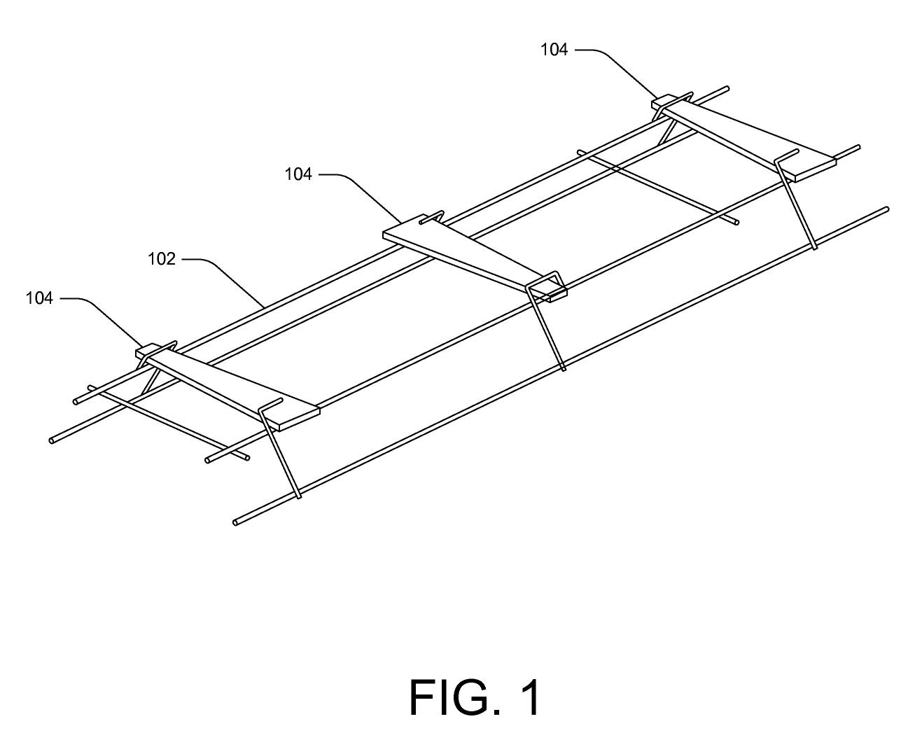

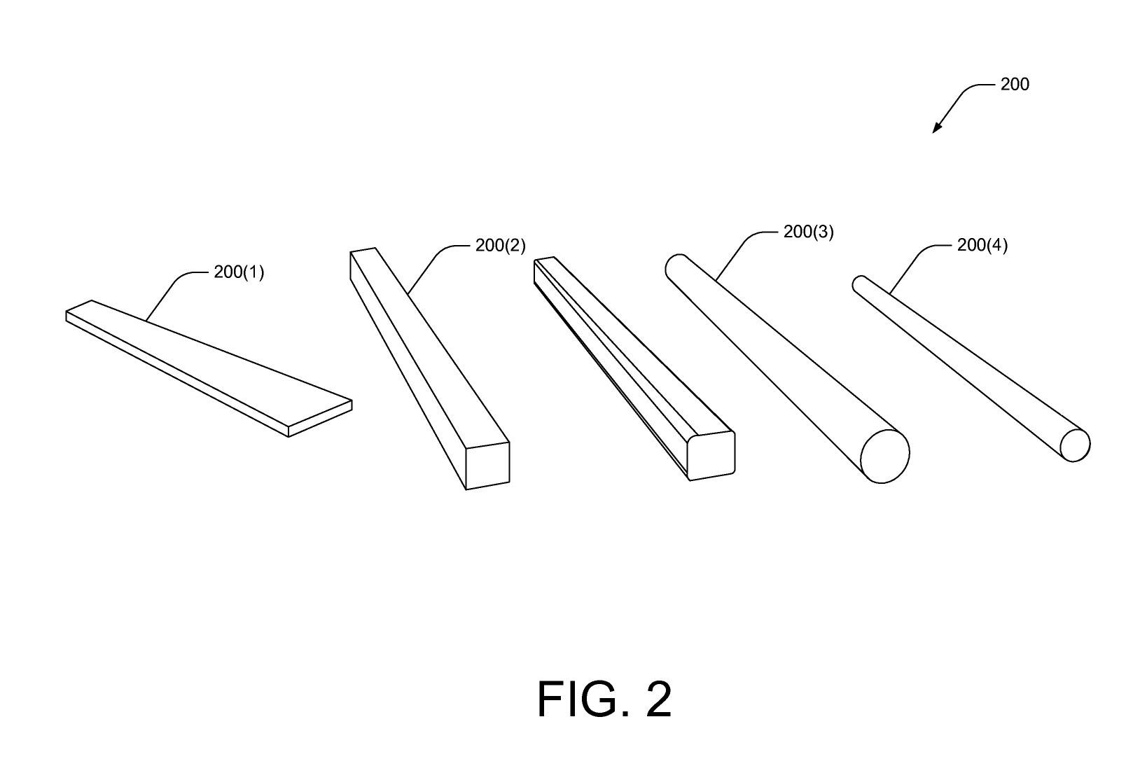

In one instance, a vapor barrier is spread over the ground before pouring concrete. Thereafter, an attachment apparatus may be coupled to the vapor barrier and a dowel basket may then be coupled to the attachment apparatus. FIG. 1 depicts an exemplary dowel basket 102 holding exemplary isometric plate dowels 104. Dowel baskets are designed to hold dowels at a certain elevation and/or position prior to the pouring of concrete, such that the dowels remain at this elevation and/or position upon hardening of the concrete. FIG. 2 depicts exemplary dowels 200 of various shapes. Dowels may take any shape, including planar (such as exemplary dowel 200(1)), square (such as exemplary dowel 200(2)), round ((such as exemplary dowels 200(3) and 200(4)), or any other shape appropriate for the intended purposes of strengthening the concrete upon drying of the concrete. That is, these dowel baskets and dowels are strategically placed to “armor the joints” of the concrete. “Armoring” the joints structurally stabilizes the joints by helping with load transfer. For example, dowels may be placed in construction joints to distribute the weight of heavy machinery or wheel traffic across the joints. Without the dowels or proper placement of the dowels, loads across the joints may cause damage to the joints.

The vapor barrier may comprise an impermeant, semi-permeant, or permeant vapor retarder. Generally, those laying concrete choose vapor retarders having a permeance of less than 1 US perm, where 1 US perm=1 grain per square-foot-hour-inch of mercury (grain/hr-ft2-in.Hg)≈57 SI perms=57 nanogram per second-square-meter-pascal (ng/s-m2-Pa). However, one may choose to use a semi-permeant vapor retarder with a permeance greater than 1 US perm and less than 10 US perms or a permeant vapor retarder with a permeance greater than 10 US perms. The vapor barrier may have any thickness. In one embodiment, the vapor barrier has a permeance of less than 0.01 perms (grain/hr-ft2-in.Hg) and a thickness of at least 15 thousandths of an inch (mils).

### Exemplary Ring-Shaped Force-Fit Attachment Apparatus

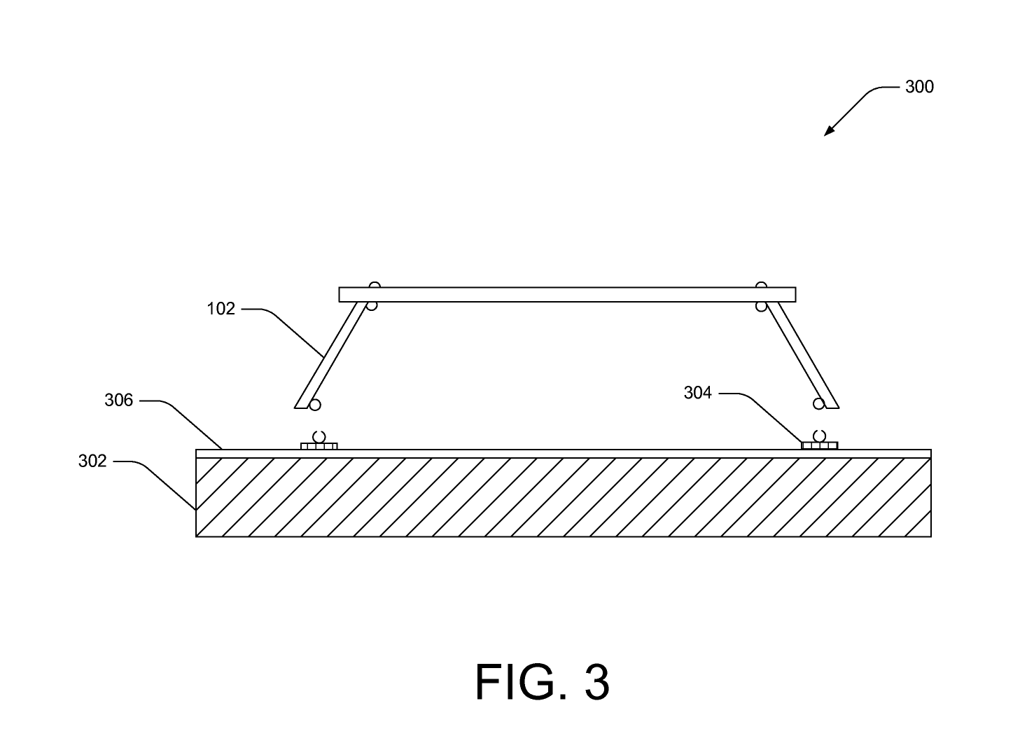

FIG. 3 depicts an exemplary environment 300 including the ground 302, an attachment apparatus 304, a vapor barrier 306, and the exemplary dowel basket 102. In one embodiment, the attachment apparatus 304 is a ring-shaped force-fit attachment apparatus that attaches to the vapor barrier on one side and that is configured to receive an accessory, such as a dowel or dowel basket, on the other side.

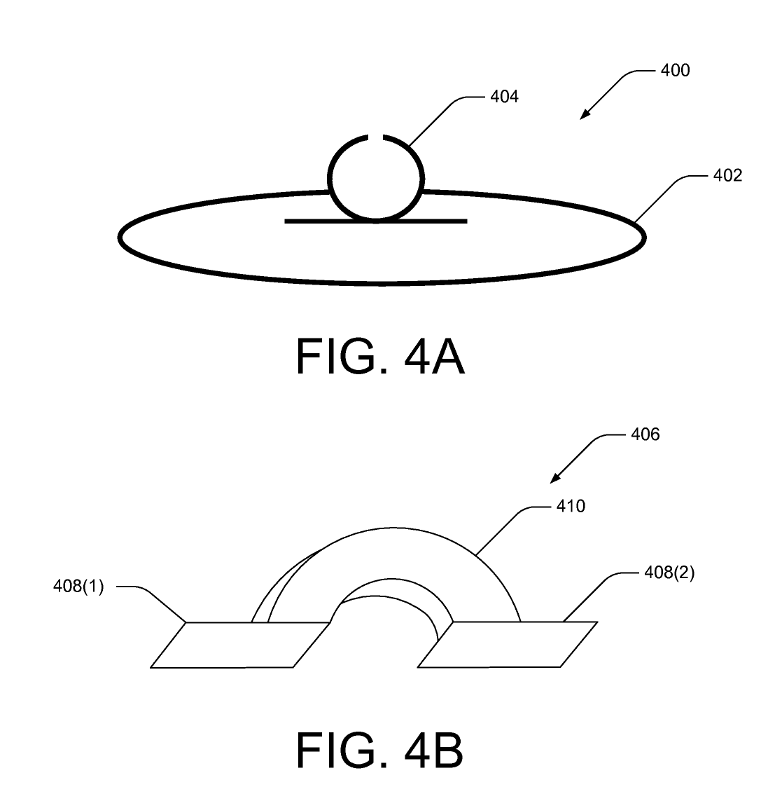

FIG. 4A depicts an exemplary ring-shaped force-fit attachment apparatus 400. In one embodiment, the ring-shaped force-fit attachment apparatus 400 comprises a base portion 402 and a retention portion 404, with the base portion 402 having a shape and dimensions to provide shear, compressive, tensile, and torsional support to the retention portion 404 and to the attached dowel basket. An adhesive such as epoxy, for example, may be applied to a side of the base portion 402 opposite the retention portion 404 and/or to the vapor barrier in order to attach or otherwise couple the base portion 402 to the vapor barrier. Any appropriate adhesive or mastic may be chosen to attach the base portion 402 to the vapor barrier. Without limitation, other methods of attachment such as vulcanization, lamination, melting, or welding may be used depending on the material of the vapor barrier and the ring-shaped force-fit attachment apparatus.

In other embodiments, the base portion 402 may be coupled to the vapor barrier using magnetism or other fasteners. If magnetism is employed, for example, a ferromagnetic, ferrous, or non-ferrous body may be placed on the ground prior to the spreading of the vapor layer. In that case, the base portion 402 of the ring-shaped force-fit attachment apparatus may further comprise a magnet attached or otherwise coupled to the base portion 402. In some embodiments, the base portion 402 itself may be composed of ferromagnetic, ferrous, or non-ferrous material in order to magnetically couple to the body beneath the vapor barrier.

The base portion 402 has a surface area, the shape and dimensions of the base portion 402 chosen such that the surface area adheres or otherwise couples the base portion 402 of the ring-shaped force-fit attachment apparatus to the vapor barrier with enough force to adequately keep the dowels in the desired position and elevation. For example, the shape and dimensions of the base portion 402 may be chosen such that the surface area of the base portion 402 is large enough to apply enough adhesive to the vapor barrier or the base portion 402 to prevent the ring-shaped force-fit attachment apparatus from shifting, thereby displacing the dowels. In another example, if magnetism is employed to couple the base portion 402 to the vapor barrier, the shape and dimensions of the base portion 402 may be chosen such that the base portion 402 provides enough magnetic force to prevent the ring-shaped force-fit attachment apparatus from shifting.

In one embodiment, the retention portion 404 is designed to couple to a portion of the accessory, dowel, or dowel basket, thereby communicatively coupling the accessory, dowel, or dowel basket to the base portion 402, which is attached or otherwise coupled to the vapor barrier. In various embodiments the retention portion 404 is a complementary shape to the shape of the portion of the accessory, dowel, or dowel basket. For example, the shape of the retention portion 404 may be generally convex and the shape of the portion of the accessory, dowel, or dowel basket may be generally concave, or vice-versa, convex and concave being complementary shapes. In one embodiment, the retention portion 404 comprises a retaining ring. Some example retaining rings that may be used in embodiments of this disclosure include, without limitation, external retaining rings, internal retaining rings, beveled retaining rings, bowed retaining rings, inverted retaining rings, radially assembled retaining rings, interlocking retaining rings, grip retaining rings, circlips, piston pin circlips, flat wire circlips, self-locking retaining rings, constant section retaining rings, staples, and spiral retaining rings or any combination thereof. The retaining ring may be used to retain or enclose at least a portion of the accessory, dowel, or dowel basket in order to couple the accessory, dowel, or dowel basket to the base portion 402 of the attachment apparatus.

In other embodiments, the retention portion 404 could be, without limitation, a square, circular, hexagonal, or any other shape sleeve; a force-fit receiver; a socket; a groove; an adhesive; a receiver for a fastener; non-ferrous, ferrous, or ferromagnetic material, or any combination thereof. In one embodiment, the retention portion 404 could be a ferromagnetic material shaped to receive and magnetically couple to the accessory, dowel, or dowel basket.

In some embodiments, one applies a force to at least a portion of the accessory, dowel, or dowel basket to couple the accessory, dowel, or dowel basket to the retention portion 404. The force applied to the portion of the accessory, dowel, or dowel basket causes the retaining portion of the ring-shaped force-fit attachment apparatus to, at least partially, restrain the accessory, dowel, or dowel basket. In another embodiment, at least a portion of the accessory, dowel, or dowel basket may be passed through the retention portion 404. In yet another embodiment, at least a portion of the accessory, dowel, or dowel basket is set on the retention portion 404. In this embodiment, some ways of restraining the accessory, dowel, or dowel basket include, without limitation, use of an adhesive, strap, or gravity.

Some example fasteners that may be used in embodiments of this disclosure include, without limitation, rivets, screws, nuts, bolts, washers, eyebolts, nails, and threaded fasteners or any combination thereof.

In embodiments of this disclosure, the ring-shaped force-fit attachment apparatus may include one or more of any plastic; stone material; ceramic; ferromagnetic, ferrous, or non-ferrous metal; metal alloy; polymer; or composites thereof, whether natural or synthetic.

### Exemplary Saddle Attachment Apparatus

FIG. 4B depicts an exemplary saddle attachment apparatus 406. In another embodiment, a saddle attachment apparatus 406 could be used. This saddle attachment apparatus may be used conjunctively with the ring-shaped force-fit attachment apparatus. In one embodiment the saddle attachment apparatus could comprise a first attaching portion 408(1), a second attaching portion 408(2), and a fitted portion 410. In this embodiment, the first attaching portion 408(1) and second attaching portion 408(2) could comprise a first surface area and second surface area, respectively, to which an adhesive may be applied. In some embodiments, an adhesive may additionally or alternatively be applied to the vapor barrier and the first and second surface areas could be situated over the adhesive and the vapor barrier. An adhesive such as epoxy, for example, may be applied to either a side of the first attaching portion 408(1) and the second attaching portion 408(2) opposite the fitted portion 410 or the vapor barrier in order to attach or otherwise couple the first attaching portion 408(1) and the second attaching portion 408(2) to the vapor barrier. Any appropriate adhesive or mastic may be chosen to attach the first attaching portion 408(1) and the second attaching portion 408(2) to the vapor barrier. Without limitation, other methods of attachment such as vulcanization, lamination, melting, or welding may be used depending on the material of the vapor barrier and the saddle attachment apparatus 406. The shape and dimensions of the first attaching portion 408(1) and the second attaching portion 408(2) may be chosen such that the surface area of the first attaching portion 408(1) and the second attaching portion 408(2) adheres or otherwise couples the first attaching portion 408(1) and the second attaching portion 408(2) to the vapor barrier with enough force to adequately keep the attached accessory, dowel, or dowel basket in the desired position and elevation. In another example, if magnetism is employed to couple the first attaching portion 408(1) and the second attaching portion 408(2) to the vapor barrier, the shape and dimensions of the first attaching portion 408(1) and the second attaching portion 408(2) may be chosen such that the first attaching portion 408(1) and the second attaching portion 408(2) provide enough magnetic force to prevent the attached accessory, dowel, or dowel basket from shifting.

In one embodiment, the fitted portion 410 resides between the first attaching portion 408(1) and the second attaching portion 408(2). The fitted portion 410 is shaped such that it couples with the accessory, dowel, or dowel basket that is to be attached to the vapor barrier. For example, to attach a dowel basket using circular rebar, the fitted portion would be appropriately sized and circularly shaped in order to encompass at least a portion of the rebar in order to affix the rebar to the vapor barrier. In another example, to attach an accessory with a square portion to be affixed, the fitted portion 410 would be appropriately sized and at least partially squarely shaped in order to at least partially couple to the square base portion.

In another embodiment, the fitted portion 410 includes at least one locking mechanism such that the saddle attachment apparatus 406 may have an open state and a locked state. When in the open state, the saddle attachment apparatus 406 is ready to accept at least a section of an accessory, dowel, or dowel basket. Further, when in the open state, the first attaching portion 408(1) and the second attaching portion 408(2) are adhesively, magnetically, or otherwise attached to the vapor barrier but the section is not yet coupled to the vapor barrier. After accepting at least the section, the saddle attachment apparatus 406 may be placed into the locked state, whereby the portion is coupled to the vapor barrier. Some example locking mechanisms that may be used in embodiments of this disclosure include, without limitation, hinges; snaps; tabs, magnetic snaps; clips; lock-jaw functionality; or any combination thereof.

In embodiments of this disclosure, the saddle attachment apparatus 406 may include one or more of any plastic; stone material; ceramic; ferromagnetic, ferrous, or non-ferrous metal; metal alloy; polymer; or composites thereof, whether natural or synthetic.

### Exemplary Retainer Clip Attachment Apparatus

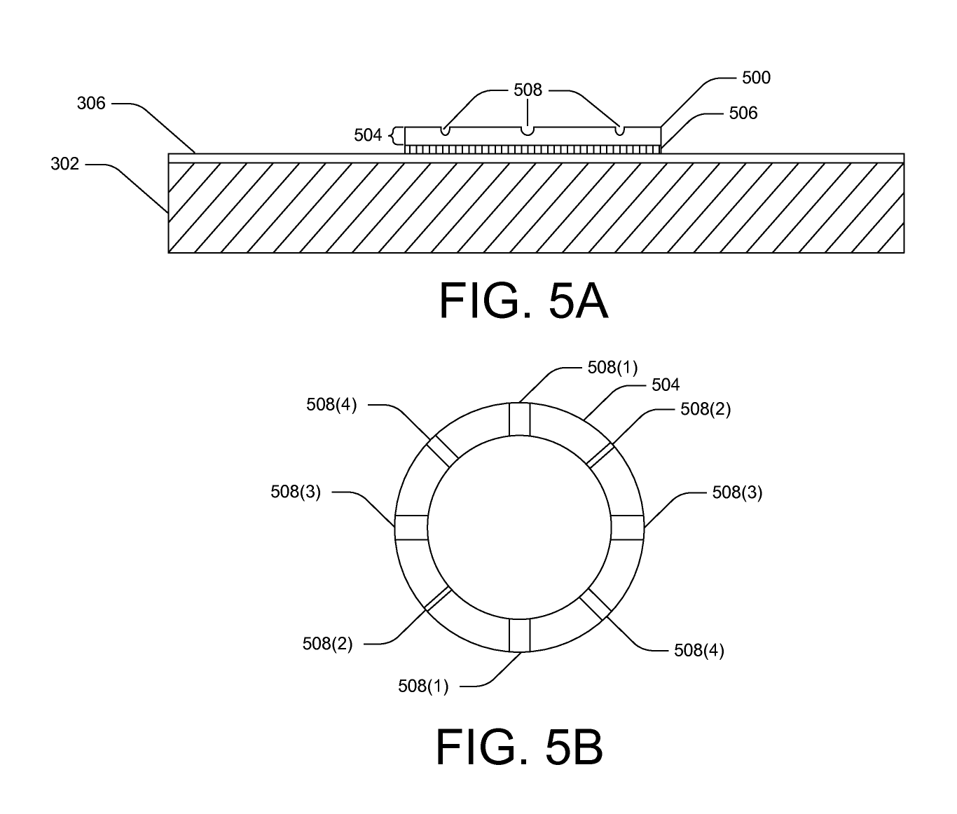

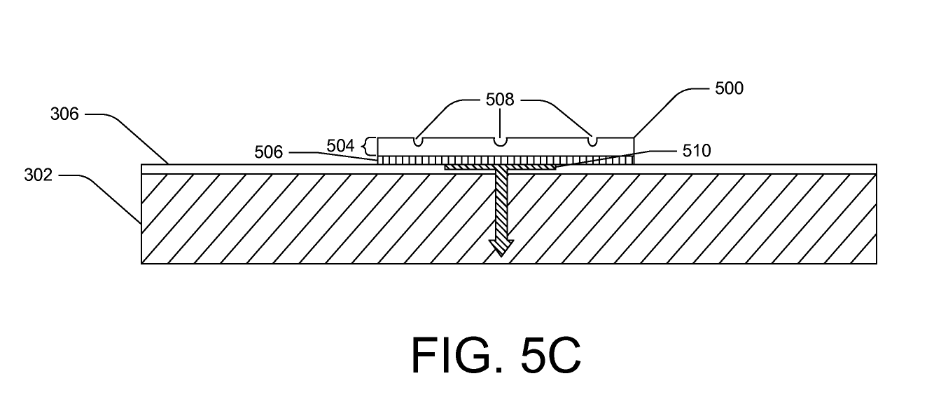

FIG. 5A depicts a side view of an exemplary retainer clip attachment apparatus 500. In at least one embodiment, the exemplary retainer clip attachment apparatus 500 comprises a retaining portion 504 and an adhesive portion 506. The exemplary retainer clip attachment apparatus 500 may comprise grooves 508 into which an object (e.g., a portion of a dowel basket) may be placed. Grooves 508 may be shaped to be substantially the same shape as the object the grooves 508 receives. In some embodiments, the grooves 508 may be shaped so as to be “force-fit” grooves. In this embodiment, force may be applied to a portion of the object in the direction of the groove. The size and shape of the grooves 508 may be chosen such that the force applied to the portion of the object causes the portion of the object to be lodged in and thereby retained by the grooves 508. Any number of the grooves 508 may be used to retain portions of the object. In some embodiments, the grooves may contain or comprise an adhesive to which the portion of the object may be adhered and thereby retained. The exemplary retainer clip attachment apparatus 500 may include one or more of any plastic; stone material; ceramic; ferromagnetic, ferrous, or non-ferrous metal; metal alloy; polymer; or composites thereof, whether natural or synthetic.

In one embodiment, the adhesive portion 506 may be a “peel-and-stick” bottom of the retaining portion 504, where an adhesive has already been applied to the bottom of the retaining portion 504 and a removable cover has been applied to the bottom of the adhesive opposite the side of the adhesive in contact with the retaining portion 504. In some embodiments, the adhesive portion 506 may be applied to the vapor barrier 306 or the bottom of the retaining portion 504 at the time the retaining portion 504 is attached to the vapor barrier 306. The adhesive may comprise any appropriate adhesive or mastic, such as, for example, non-reactive adhesives (e.g., drying adhesives, pressure-sensitive adhesives, contact adhesives, or hot adhesives) or reactive adhesives. Without limitation, other methods of attachment such as hook-and-loop connectors, vulcanization, lamination, melting, or welding may be used depending on the material of the vapor barrier and/or the exemplary retainer clip attachment apparatus 500. The removable cover may be any material that will not interfere with the integrity of the adhesive and that may easily be removed by human fingers. For example, such material may comprise wax paper, plastic, or rubber.

FIG. 5B depicts a top view of an exemplary retainer clip attachment apparatus 500. In one embodiment, the retaining portion 504 may comprise grooves of varying sizes to accommodate different object portion shapes and sizes (e.g., different standard dowel shapes and sizes). In one embodiment, the retaining portion 504 may comprise sets of grooves. For example, the retaining portion 504 may comprise sets of grooves 508(1), 508(2), 508(3) and 508(4) that all have a generally circular shape but that have different diameters to accommodate different circularly sized object portions. In another example, the grooves 508 may vary based on shape and not size. Any number of the grooves 508 may be used to retain a portion of an object. In one embodiment, both grooves of a set of the grooves, such as the set of grooves 508(4), may be used to retain a portion of one or more objects.

FIG. 5C depicts an exemplary retainer clip attachment apparatus 500 having a retaining portion 504 and an adhesive portion 506 attached to a retainer pin 510. In some embodiments, the retainer pin 510 punctures the vapor barrier 306 and the ground 302 before the exemplary retainer clip attachment apparatus 500 is adhered to the top of the retainer pin 510. In other embodiments, the retainer pin 510 does not puncture the vapor barrier when force is applied against the retainer pin 510 to set the retainer pin 510 in the ground 302. The vapor barrier 306 may be designed to flex with the retainer pin 510. In some embodiments, the retainer pin 510 may be any pin or stake that will further stabilize the retainer clip attachment apparatus 500. The retainer pin 510 may have a wide head in order to prevent seepage from the ground 302 in the embodiment where the vapor barrier 306 is perforated by the retainer pin 510. The retainer pin 510 may include one or more of any plastic; stone material; ceramic; ferromagnetic, ferrous, or non-ferrous metal; metal alloy; polymer; or composites thereof, whether natural or synthetic.

### Other Exemplary Attachment Apparatus

In another embodiment, the attachment apparatus may be a self-sealing stake. After laying the vapor barrier, accessories, dowels, or dowel baskets could be placed on top of the vapor barrier and self-sealing stakes could be driven through the vapor barrier. In one embodiment, after driving the stake, a sealant would be released by the stake or applied to the area around the stake. The sealant may be bentonite, a mastic, or any other appropriate sealant or a combination thereof. In another embodiment a rubber flange may be employed. The rubber flange could be attached to the stake before driving it or the stake could be driven through the rubber flange in order to preserve the integrity of the vapor barrier.

1. A method of securing an object to a vapor barrier comprising:
adhering a base portion of an attachment apparatus to the vapor barrier, the attachment apparatus comprising a retention portion; and
attaching the object to the retention portion.

2. The method of claim 1, wherein the retention portion comprises a retaining ring.

3. The method of claim 2, wherein attaching the object to the retention portion includes enclosing at least a portion of the object using the retaining ring.

4. The method of claim 2, wherein attaching the object to the retention portion comprises applying force to at least one of the object or the retaining ring.

5. The method of claim 1, wherein the adhering includes one or more of attaching, sticking, gluing, vulcanizing, laminating, removing a removable cover from an adhesive and placing the adhesive on a surface, or welding the base portion of the attachment apparatus to the vapor barrier.

6. The method of claim 1, wherein the adhering and attaching does not perforate the vapor barrier.

7. An apparatus comprising:
a base portion to adhere to a vapor barrier; and
a retention portion to receive at least a portion of the object.

8. The apparatus of claim 7, wherein the object includes a dowel basket.

9. The apparatus of claim 7, wherein the retention portion comprises a generally circular ring for receiving the object.

10. The apparatus of claim 9, wherein the object is pressure fit to the generally circular ring when attached.

11. The apparatus of claim 7, wherein at least one of:
the base portion comprises a peel-and-stick adhesive;or
the retention portion comprises one or more grooves, the one or more grooves configured to retain at least a portion of the object.

12. A device for attaching an object to a barrier comprising:
a first attaching portion;
a second attaching portion; and
a fitted portion.

13. The device of claim 12, wherein the fitted portion is disposed between the first attaching portion and the second attaching portion.

14. The device of claim 12, wherein the first attaching portion and the second attaching portion are adhered to the barrier, the fitted portion being configured to be disposed over at least a section of the object.

15. The device of claim 14, wherein the fitted portion is configured to restrain movement of at least a section of the object.

16. The device of claim 12, wherein the device is configured to restrain movement of at least a section of the object without perforating the barrier.

17. The device of claim 12, wherein the fitted portion includes at least one locking mechanism, the locking mechanism configured to have an open state and a closed state, the open state configured to not restrain at least a section of the object and the closed state configured to restrain the section of the object.

18. The device of claim 12, wherein the fitted portion has a shape complementary to a shape of a section of the object.

19. The device of claim 12 further comprising an attachment mechanism, the mastic disposed on a surface area of the first attaching portion and a surface area of the second attaching portion.

20. The device of claim 12, wherein the object includes at least a portion of a dowel basket.
